(19) United States
(12) Patent Application Publication
(10) Pub. No.: US 2006/0204817 A1
(43) Pub. Date: Sep. 14, 2006

(54) Fuel cell device and electronic appliance

(75) Inventor: Atsushi Yamaguchi, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/179,480

(22) Filed: Jul. 13, 2005

(30) Foreign Application Priority Data
Mar. 10, 2005 (JP) 2005-067867

(51) Int. Cl. H01M 8/04; H01M 8/10; H01M 16/00

(52) U.S. Cl. 429/34; 429/25; 429/30; 429/22; 429/9

(57) ABSTRACT

The present invention relates to a fuel cell device using a liquid fuel, improves recovery of moisture contained in the exhaust air discharged from the fuel cell, and simplifies structure of generated water recovery. The fuel cell device is a fuel cell device 2 using the liquid fuel (diluted fuel M), and includes a water separation part 16 capable of separating water from exhaust air generated in the fuel cell 4, to which the fuel m as well as an air Ar are supplied, by letting the exhaust air pass through and by causing pressure changes in the exhaust airflow. The water separation part is constructed in such a manner that it includes a narrow portion formed in channels where the exhaust air passes through for causing pressure changes in the exhaust air passing thereat.

### BACKGROUND OF THE INVENTION

1. Field of the Invention

The present invention relates to a fuel cell device using a liquid fuel, and more specifically to a fuel cell device suitable for a power source to be mounted on a personal computer or a mobile terminal device, and an electronic appliance mounting such a device.

2. Description of the Related Art

A fuel cell is constructed such that a polyelectrolyte membrane is disposed as a proton-conducting or electron-conducting material; a fuel electrode is disposed on one side of the electrolyte membrane; and an oxidizer electrode is arranged opposite to the fuel electrode, wherein a liquid fuel such as a methanol aqueous solution including hydrogen component is supplied to the fuel electrode whereas air including oxygen component is supplied to the oxidizer electrode. The electrolyte membrane allows hydrogen protons in the liquid fuel at the fuel electrode side to pass through to couple to oxygen in the air at the oxidizer electrode side. Since electrons remaining in the hydrogen in the liquid fuel are extracted to outside as electricity by this coupling, this functions as a cell.

In such a fuel cell, when methanol is used as a liquid fuel, water (steam vapors) is generated at the oxidizer electrode side by the reaction of hydrogen and oxygen, and carbon dioxide (CO₂) is generated at the fuel electrode side by decomposition of methanol. In this processing, if electricity is generated through such an ideal chemical reaction in which 1 mole of methanol and 1 mole of water are consumed at the fuel electrode whereas 1 mole of oxygen is consumed at the oxidizer electrode, then 3 moles of water are generated at the oxidizer electrode side and 1 mole of carbon dioxide is generated at the fuel electrode side.

In a fuel cell device comprising such a fuel cell, a fuel tank is provided in order to supply a liquid fuel to the fuel cell. Although using a high-concentration fuel can reduce the size of the fuel tank, a high performance is required for the electrolyte membrane. If the electrolyte membrane has a low performance, using a high-concentration fuel increases the amount of fuel consumption and worsens the efficiency of electricity generation. Moreover, by using a high-concentration fuel, there arises a possibility of shortening lives of component materials of the fuel cell, for example, the electrolyte membrane, catalyst materials such as platinum supported carbon, and adhesive materials to bond them. With all things considered, it is recommended to use a fuel having about 1 mol concentration by keeping a high-concentration fuel in the fuel tank and by diluting the fuel to about 1 mol concentration. In this case, diluting the high-concentration fuel requires water as a diluent and a diluted fuel tank to store the fuel diluted with water. Since driving the fuel cell consumes the fuel, a water level sensor monitors a water level of the diluted fuel tank as well as a concentration sensor monitors a concentration of the fuel, and based on them, replenishing volumes of water and fuel are controlled.

Among patent documents related to processing of such generated water in a fuel cell device, there are ones that use an electrolyte membrane and a liquid fuel in the fuel cell structure and recover generated water in the fuel cell (e.g., Japanese Patent Application Laid-Open Publication No. 2003-297401 (paragraph No. 0023, FIG. 1, etc.), No. 2002-313383 (paragraph Nos. 0025, 0026, 0033, FIG. 1, etc.)); one that recovers steam vapors generated at an oxidizer electrode by using a moisture recovering mechanism (e.g., No. 2004-152561 (paragraph Nos. 0009, 0016, FIGS. 1, 3, etc.)); and one that is equipped with a generated water absorbing and releasing portion disposed at a joining portion of unit cells comprising a fuel cell (e.g., No. 2002-15763 (paragraph Nos. 0021, 0022, 0023, 0040, 0041, FIGS. 1, 3, 4, etc.)).

By the way, Patent Application Laid-Open

Publication No. 2003-297401 has disclosed a configuration in which a heat pipe is provided in a gas-liquid separation container for separating moisture from exhaust air, however, the heat pipe uses a sealed pipe filled with a volatile liquid or the like so that configuration for separating moisture from the exhaust air is complicated. Furthermore, although Patent Application Laid-Open Publication No. 2002-313383 has disclosed a configuration in which a water recovery mechanism comprises an air-supply pump for sending air and steam vapors discharged from a fuel cell, and a cold trap or the like for condensing and recovering the steam vapors, its structure is complicated. Moreover, in a configuration disclosed in Patent Application Laid-Open Publication No. 2004-152561, generated water is released so that efficiency of recovering the generated water is inevitably lowered.

The objective of recovering such steam vapors is to render it reusable as a diluent (water) and to avoid harmful effect of moisture by being carried to outside the fuel cell device. According to the technology disclosed in Patent Application Laid-Open Publication No. 2004-152561, uncollected water is released.

If such exhaust air containing moisture is carried to outside the fuel cell device, there arises inconvenience of dew condensation by a temperature difference of the outside air or of the outer wall of adjoining devices. Leaving such dew condensation as it is causes troubles in the adjoining devices and the like. Therefore, in order to prevent dew condensation, the generated water needs to be recovered. Regarding such issues as to recovery of the generated water in order to prevent dew condensation and as to a way to increase recovery rate, none of the above-described Patent Application Laid-Open Publication Nos. 2003-297401, 2002-313383, 2004-152561, and 2002-15763 discloses at all, nor discloses or suggests any solution for the issues.

### SUMMARY OF THE INVENTION

It is therefore an object of the present invention to increase recovery of moisture contained in the exhaust air discharged from a fuel cell, regarding a fuel cell device using a fuel cell.

Another object of the present invention is to simplify a recovery structure of generated water.

To attain the above-described objects, according to a first aspect of the present invention there is provided a fuel cell device using a liquid fuel, comprising a water separation part enabling to separate water from exhaust air generated in the fuel cell to which the fuel is supplied along with air, by letting the exhaust air pass through and by producing pressure changes in the exhaust airflow.

According to such a configuration, the air as well as the fuel is supplied to the fuel cell and electricity is generated through chemical reaction of the air and the fuel. In this electricity generation, excessive air is discharged from the fuel cell, and in this exhaust air, moisture (generated water) is contained. In the exhaust air discharged from the fuel cell, exhaust airflow is produced by the air supply and this exhaust airflow is introduced to the water separation part. The water separation part causes pressure changes in the exhaust airflow passing thereat, for example, by lowering the pressure from a high-pressure state to a low-pressure state, so that steam vapors in the exhaust air condenses into water to be separated from the exhaust air. In this way, since steam vapors are condensed through pressure changes, moisture recovery can be improved. In addition, moisture recovery structure can be simplified as well.

To attain the above-described objects, in this fuel cell device, the water separation part may further comprise channels for flowing the exhaust air, the channels including a narrow portion formed therein to cause pressure changes in the exhaust air passing thereat to enable separation of water from the exhaust air.

According to such a configuration, in the fuel cell, the exhaust air is generated in accordance with velocity of the air supplied. Therefore, in order to cause a pressure drop in the exhaust air from a high-pressure state to a low-pressure state at the water separation part to which this exhaust air is introduced, a narrow portion having narrow cross-sectional area may be formed in the channels of the water separation part. The exhaust airflow having passed through such channels drops its pressure by traveling from a narrow area to a wide area in accordance with velocity of the airflow. As a result, steam vapors contained in the exhaust air are condensed and thus the generated water can be recovered.

To attain the above-described objects, in this fuel cell device, the water separation part may further comprise fins disposed in channels for flowing the exhaust air, in such a manner that a narrow portion is formed in the channels.

According to such a configuration, the exhaust air passing through the channels of the water separation part dissipates heat by the fins disposed in the channels, undergoes cooling, and causes pressure changes due to the narrow portion formed by disposing fins in the channels. As a result, the generated water can be separated efficiently from the exhaust air.

To attain the above-described objects, this fuel cell device may further comprise a water recovery tank for recovering the water separated by the water separation part, wherein the water recovered into the water recovery tank is used as diluting water for the liquid fuel.

According to such a configuration, as described above, the generated water can be separated from the exhaust air by the water separation part, and this generated water can be stored into the water recovery tank. The generated water recovered into this water recovery tank is used as diluting water for the fuel, and circulates again to the fuel cell from the water recovery tank. Thus, the water recovered efficiently can be reused as diluting water, which contributes to prevent dew condensation caused by being discharged to the outside air.

To attain the above-described objects, in this fuel cell device, the fuel cell may further comprise an airflow mechanism for sending the air to the fuel cell with pressure.

To attain the above-described objects, in this fuel cell device, the fuel cell may further comprise a stack structure formed of a plurality of cell groups consisting of a plurality of cells disposed in a flat shape and air channels formed among each cell group.

To attain the above-described objects, in this fuel cell device, the fuel cell may be configured to flow the air from the airflow mechanism into the air channels formed among the respective cell groups constructed by stacking a plurality of cell groups consisting of a plurality of cells and to discharge the air having passed through the cell groups.

To attain the above-described objects, in this fuel cell device, the water separation part may be integrated with the fuel cell and the airflow mechanism supplying air to an oxidizer electrode of the fuel cell.

To attain the above-described objects, in this fuel cell device, the fuel cell may be comprised of an oxidizer electrode supplying the air to one side of an electrolyte membrane and a fuel electrode supplying a fuel to the other side of the electrolyte membrane, the electrodes being disposed sandwiching the electrolyte membrane.

To attain the above-described objects, in this fuel cell device, the water recovery tank may be disposed adjacent to the water separation part to recover the water dropped from the water separation part.

To attain the above-described objects, in this fuel cell device, the electrolyte membrane may be a permeable membrane letting protons or electrons pass through.

To attain the above-described objects, this fuel cell device may further comprise a stabilization circuit for extracting electricity output from the fuel cell after stabilization; and a battery charged by receiving the output from this stabilization circuit.

To attain the above-described objects, according to a second aspect of the present invention there is provided a fuel cell device using a liquid fuel, comprising: a diluted fuel tank for storing a diluted fuel diluted with water; a concentration sensor for detecting a concentration of the diluted fuel in the diluted fuel tank; a fuel tank for storing fuel; a water tank for storing water; and a concentration control part for maintaining concentration of the diluted fuel to a predetermined concentration by supplying the fuel from the fuel tank and the water from the water tank to the diluted fuel tank, depending on a detected concentration by the concentration sensor. According to such a configuration, since the concentration sensor detects fuel concentration in the diluted fuel and then the concentration control part controls supply of the fuel and the water supplied from the fuel tank and the water tank respectively in accordance with the detected concentration, the diluted fuel can be maintained to a suitable concentration.

To attain the above-described objects, according to a third aspect of the present invention there is provided an electronic appliance, comprising the above-described fuel cell device in its power source part. According to such a configuration, the generated water in the fuel cell is efficiently recovered through the separation from the exhaust air so that dew condensation can be prevented and accordingly reliability of the electronic appliance can be enhanced.

According to a fuel cell device of the present invention, since it is configured to separate water by pressure changes caused in the exhaust air, efficiency of water recovery can be enhanced.

In this fuel cell device, by configuring such that water is separated by pressure changes caused in the exhaust air, efficiency of water recovery can be enhanced as well as simplification of water recovery structure can be realized.

In this fuel cell device, by reusing the water recovered from the exhaust air of the fuel cell as diluting water for the fuel, efficient electricity generation can be performed.

According to an electronic appliance of the present invention, since the appliance is equipped with the above-described fuel cell device, water can be recovered efficiently from the exhaust air of the fuel cell; water discharge that causes dew condensation can be prevented; and reliability of the electronic appliance can be enhanced.

Other objects, features and advantages of the present invention will become more apparent from the following detailed description of the embodiments with reference to the accompanying drawings.

### BRIEF DESCRIPTION OF THE DRAWINGS

FIG. 1 is a diagram showing a fuel cell device according to a first embodiment;

FIG. 2 is a diagram showing an outline of a configuration of a fuel cell and its output part;

FIG. 3 is a flowchart showing a control processing;

FIG. 4 is a diagram showing a fuel cell device according to a second embodiment;

FIG. 5 is a plan view showing an airflow mechanism, a fuel cell, and a water recovery mechanism;

FIG. 6 is a diagram showing an airflow mechanism, a fuel cell, and a water recovery mechanism;

FIG. 7 is a diagram showing a configuration example of a fuel cell and airflow direction of air;

FIG. 8 is a diagram showing a channel configuration of exhaust airflow from the fuel cell to the outside air via the water recovery mechanism;

FIG. 9 is a diagram showing water recovery ratio to airflow amount of per unit area of opening;

FIG. 10 is a diagram showing a fuel cell device according to a third embodiment;

FIG. 11 is a diagram showing a fuel cell device according to a fourth embodiment;

FIG. 12 is a block diagram showing a PC according to a fifth embodiment;

FIG. 13 is an exploded perspective view showing a configuration of a PC;

FIG. 14 is an exploded perspective view showing a configuration example of a PDA according to a sixth embodiment;

FIG. 15 is an exploded perspective view showing a configuration example of a mobile phone according to a seventh embodiment;

FIG. 16 is an exploded perspective view showing a lighting fixture according to other embodiments; and

FIG. 17 is a diagram showing a fuel cell device according to other embodiments.

### DETAILED DESCRIPTION OF THE PREFERRED EMBODIMENTS

### First Embodiment

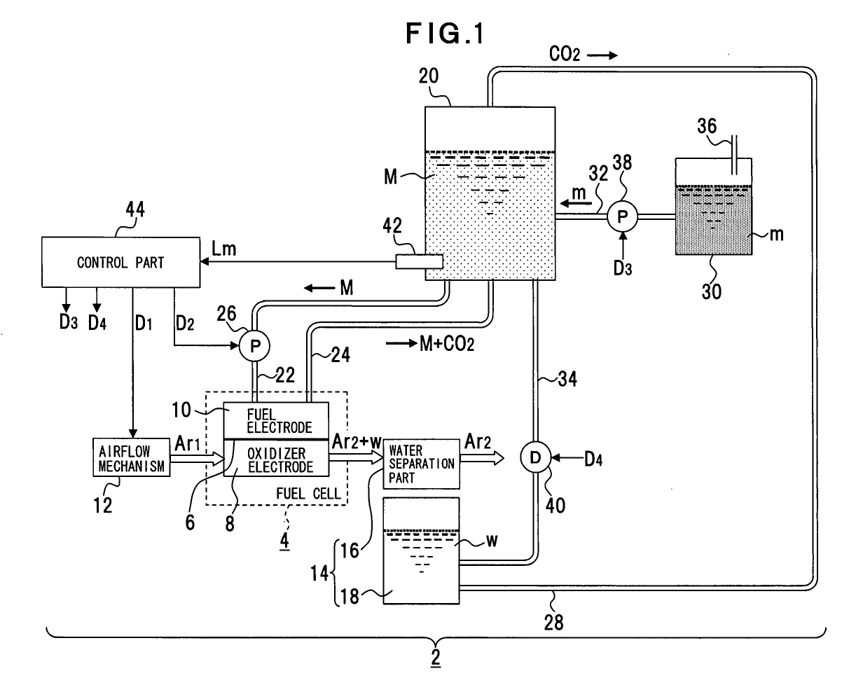

A first embodiment of the present invention will be described with reference to FIG. 1. FIG. 1 is a diagram of a fuel cell device according to a first embodiment.

This fuel cell device 2 includes a fuel cell 4 that generates electricity by using a fuel. In this fuel cell 4, an electrolyte membrane 6, an oxidizer electrode 8, and a fuel electrode 10 are disposed. The oxidizer electrode 8 and the fuel electrode 10 are disposed sandwiching the electrolyte membrane 6, and the oxidizer electrode 8 supplies air containing oxygen component to one side of the electrolyte membrane 6, while the fuel electrode 10 supplies a liquid fuel containing hydrogen component, for example, a methanol aqueous solution or the like to the other side of the electrolyte membrane 6. The electrolyte membrane 6 is a permeable membrane formed by a proton-conductive or electron-conductive material, and is comprised of a polyelectrolyte membrane such as a proton-conductive solid polymer membrane composed of perfluorsulfonic acid “Nafion” (registered tradename of Du Pont) or the like. Therefore, hydrogen protons from liquid fuel of the fuel electrode 10 side pass through the electrolyte membrane 6, and these hydrogen protons are coupled to oxygen in the air supplied from the oxidizer electrode 8 side. As a result of this coupling, electrons remaining in the hydrogen in the liquid fuel are extracted outside as electricity and this action of electricity generation functions as a cell.

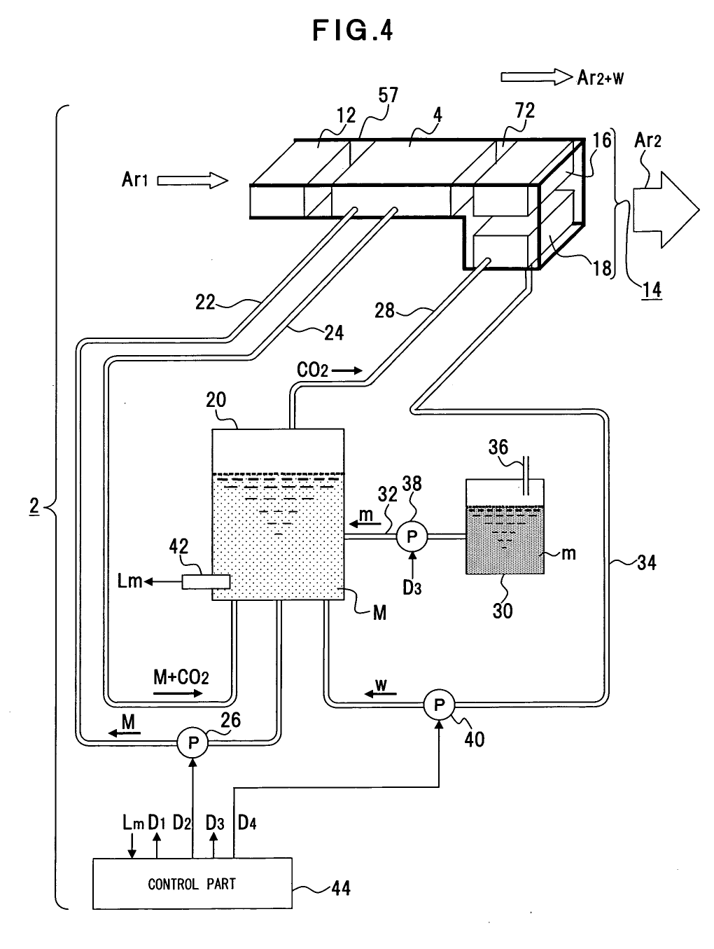

An airflow mechanism 12 is disposed as an air supply part of the oxidizer electrode 8, and an air Ar1 containing oxygen O₂ is supplied by the drive of the airflow mechanism 12. The fuel cell 4 consumes oxygen by the reaction with the fuel as well as yields water “w” generated by the reaction (hereinafter simply referenced as “water”) and carbon dioxide CO₂. The water w has been vaporized and is discharged from the oxidizer electrode 8 side along with an excessive air Ar2 containing carbon dioxide CO₂. Therefore, for the airflow mechanism 12, for example, a pump or the like that has a comparatively high airflow pressure power is suitable in order to send the air to the oxidizer electrode 8 side of the fuel cell 4 and to obtain enough amount of the exhaust air. In addition, in order to produce enough exhaust airflow at the vent side of the fuel cell 4, either a duct structure (FIG. 4) or a piping connection structure can be used for the connection portion between the airflow mechanism 12 and the fuel cell 4.

At the discharge part of the oxidizer electrode 8, a water recovery mechanism 14 for recovering the water w by separating the water from the excessive air (exhaust air) Ar2 is disposed, and this water recovery mechanism 14 includes a water separation part 16 and a water tank 18. The water separation part 16 separates the water w from the excessive air Ar2 at the discharge part of the oxidizer electrode 8 by releasing heat or by cooling down, with fins provided therein and discharges the excessive air Ar2 in which the water w is removed. The moisture contained in the excessive air Ar2 is separated from the excessive air Ar2 by being condensed into the water w through heat radiation, pressure change, and cooling down while passing through the water separation part 16. The water tank 18 is disposed, for example, below the water separation part 16 in order to receive the dropping water w, and recovers and stores the water w separated from the excessive air Ar2 at the water separation part 16. That is, the water tank 18 serves as a water recovery tank recovering the water w and also as a diluting water tank since the water w stored therein is reused as diluting water for a liquid fuel m.

By the way, in this fuel cell 4, when methanol is used as a liquid fuel, the water w (steam vapors) is generated at the oxidizer electrode 8 side by the reaction of hydrogen and oxygen via a proton catalyst of the electrolyte membrane 6, and carbon dioxide is produced as bubbles at the fuel electrode 10 side by the decomposition of methanol. For instance, if the generation of electricity through such an ideal chemical reaction is performed wherein 1 mole of methanol and 1 mole of water are consumed at the fuel electrode 10 side whereas 1 mole of oxygen is consumed at the oxidizer electrode 8 side, then after the power generation, about 3 moles of water are generated at the oxidizer electrode 8 side and about 1 mole of carbon dioxide is generated at the fuel electrode 10 side.

Further, to the fuel electrode 10, a diluted fuel tank 20 is attached via an outgoing pipe 22 and a return pipe 24 as fuel circulation paths, and a circulation pump 26 is disposed in the outgoing pipe 22. A diluted fuel M is sent with pressure to the fuel electrode 10 of the fuel cell 4 from the diluted fuel tank 20 by the circulation pump 26, and then circulates to the fuel electrode 10. In this case, unreacted fuel M and carbon dioxide CO₂ flow from the fuel electrode 10 into the diluted fuel tank 20 via the return pipe 24, thereby the unreacted fuel M is mixed in the diluted fuel M. The carbon dioxide introduced into the diluted fuel tank 20 is separated from the unreacted fuel M, and is introduced into the water w in the water tank 18 via the exhaust pipe 28 that is connected between the diluted fuel tank 20 and the water tank 18. In this case, even if the air Ar2 enters into the return pipe 24, the air is separated from the unreacted fuel M similarly and introduced into the water tank 18 via the exhaust pipe 28. The air Ar2 and carbon dioxide CO₂ introduced into the water tank 18 flow to the water separation part 16 side and are discharged.

To the diluted fuel tank 20, a liquid fuel tank 30 is connected via a fuel supply pipe 32 as well as the water tank 18 is connected via a water supply pipe 34. In the liquid fuel tank 30, for example, methanol is stored as the liquid fuel m and an exhaust outlet 36 is formed thereon. The fuel supply pipe 32 is provided with a fuel pump 38 and the water supply pipe 34 is provided with a water pump 40. Accordingly, the liquid fuel m is supplied to the diluted fuel tank 20 by the drive of the fuel pump 38, and the water w is supplied by the drive of the water pump 40. With supplies of these liquid fuel m and water w, the diluted fuel M (=m+w) is produced and stored into the diluted fuel tank 20.

In addition, a concentration sensor 42 for detecting a fuel concentration of the diluted fuel M is disposed in the diluted fuel tank 20. This concentration sensor 42 issues a detection signal Lm representing a fuel concentration of the diluted fuel M, and this detection signal Lm is added to a control part 44 as control information.

The control part 44 consists of microprocessors and the like, and with control programs, executes various kinds of operation controls such as decision of fuel anomalous or the like, generation of its display output, fuel supply to the fuel cell 4, and level control of the diluted fuel M. Therefore, the control part 44, with the receipt of the detection signal Lm and the like, issues driving signals D1, D2, D3, D4 and the like, whereby a fan motor at the airflow mechanism 12 is driven by the driving signal D1; the circulation pump 26 is driven by D2; the fuel pump 38 is driven by D3; and the water pump 40 is driven by D4. That is, the control part 44 controls fuel supply and water supply to the diluted fuel tank 20 by detecting a concentration with the concentration sensor 42, and also serves as a concentration control part for controlling fuel concentration of the diluted fuel M.

In this embodiment, if the amount of the liquid fuel m to be supplied to the diluted fuel tank 20 from the liquid fuel tank 30 of a predetermined capacity is known, then by monitoring fuel concentration of the diluted fuel M through the detection signal Lm from the concentration sensor 42, the amount of the water w (diluting amount) to be supplied in accordance with the supply amount of the liquid fuel m can be controlled optimally. Further, since the amount of the diluted fuel M consumed depends on operation hours of the fuel cell 4, and accordingly by controlling either or both of the fuel pump 38 and the water pump 40, the diluted fuel M is produced and then supplied to the fuel cell 4. In reality, there is the case in which the diluted fuel M and the water w are not consumed in equal moles since there are extra diluted fuel M and water w passing through the electrolyte membrane 6, however, this can be coped with by previously drawing a calibration curve representing the amount of the diluted fuel M consumed in the fuel cell 4 and by adjusting, based on the curve, replenishing volume of the fuel m and the water w to the capacity of the fuel cell 4.

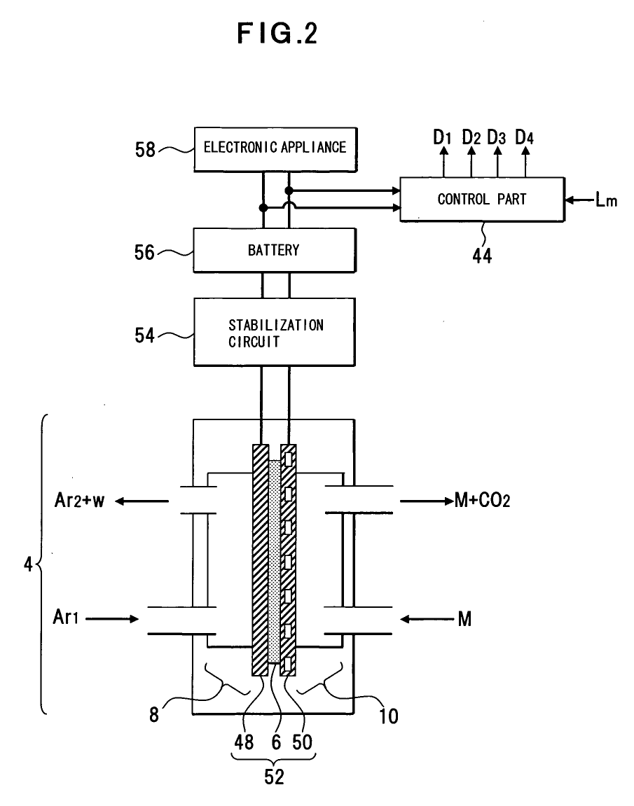

Next, a configuration of the fuel cell 4 and its output extraction will be described with reference to FIG. 2. FIG. 2 is a diagram showing a configuration outline of the fuel cell 4 and its output part. In FIG. 2, the same symbols are assigned to parts identical to those of the fuel cell device 2 shown in FIG. 1.

An oxidizer electrode 48 is disposed at the oxidizer electrode 8 and a fuel electrode 50 is disposed at the fuel electrode 10. The electrolyte membrane 6 is disposed, sandwiched between the oxidizer electrode 48 and the fuel electrode 50. In this fuel cell 4, a layered product formed of the electrolyte membrane 6 and the oxidizer electrode 48 and the fuel electrode 50 comprises an electrolyte plate 52.

Further, a battery 56, for example, is connected to the oxidizer electrode 48 and the fuel electrode 50 as a rechargeable secondary cell via a stabilization circuit 54. The electricity generated at the oxide electrode 48 and the fuel electrode 50 is applied to the battery 56 after having been stabilized by the stabilization circuit 54, and the battery 56 is charged by the output of the fuel cell 4. The output of this battery 56 is applied to an electronic appliance 58 that comprises the fuel cell device 2 as its power source. This electronic appliance 58 may include, for example, a personal computer (PC), a mobile phone, or the like. Furthermore, terminal voltage of the battery 56 that feeds the electronic appliance 58 is added to the control part 44 as charging information representing a charging condition. In this case, operational information representing whether the electronic appliance 58 is in operation or out of operation is added to the control part 44.

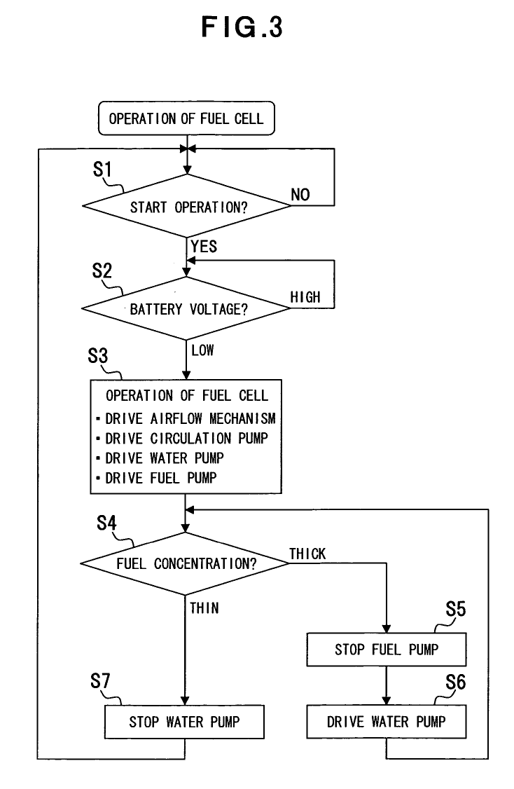

Next, operations of this fuel cell device 2 will be described with reference to FIG. 3. FIG. 3 is a flowchart showing a control processing executed by the control part 44.

With an issue of driving order to the control part 44, the processing is started. Then it is judged whether or not the fuel cell starts operating, or whether or not the fuel cell is in operation (step S1), and its voltage information representing charged voltage of the battery 56 is imported to the control part 44. When its voltage is high enough, for example, when it is higher than the reference voltage Vref, as it's not necessary to charge, the control part 44 waits for further operation without operating the fuel cell 4 (step S2). Contrary to this, when the charged voltage of the battery 56 is less than the reference voltage Vref, the control part 44 operates the fuel cell 4 and supply the air Ar1 to the fuel cell 4 as well as circulates the diluted fuel M (step S3). In this case, the airflow mechanism 12 and the circulation pump 26 are driven; the air Ar1 is supplied to the oxidizer electrode 8 by the airflow mechanism 12 as well as the diluted fuel M circulates from the diluted fuel tank 20 to the fuel electrode 10. At this time, by driving the fuel pump 38 and the water pump 40, the liquid fuel m and the water w are supplied to the diluted fuel tank 20.

Under such operation states, concentration of the liquid fuel m of the diluted fuel M is monitored by the detection signal Lm from the concentration sensor 42 (step S4). When the fuel concentration is high (thick), the fuel pump 38 is stopped (step S5); driving of the water pump 40 is maintained in order to optimize the fuel concentration (step S6); and the fuel concentration is lowered by supplying the diluted fuel tank 20 with the water w diluting water. Or when the fuel concentration is low (thin), the water pump 40 is stopped (step S7); and the fuel pump 38 is driven via the steps of S1 and S2, in order to supply the liquid fuel m from the liquid fuel tank 30 to the diluted fuel tank 20, and thus to increase the fuel concentration.

Such operation states continue until a stop order is issued, or until the charged voltage of the battery 56 reaches the reference voltage Vref. When the charged voltage of the battery 56 is lowered by the electricity consumption of the electronic appliance 58, the operation of the fuel cell 4 is restarted and electricity necessary for the electronic appliance 58 is supplied via the battery 56.

By the way, by operating the fuel cell 4, the air Ar1 is supplied to the oxidizer electrode 8 by the airflow mechanism 12 and the diluted fuel M is supplied to the fuel electrode 10 to generate electricity. Using methanol for the liquid fuel m, as described above, yields the water w (steam vapors) at the oxidizer electrode 8 side by the reaction of hydrogen and oxygen contained in the air Ar1, and yields carbon dioxide CO₂ at the fuel electrode 10 side by the decomposition of methanol. If such an ideal chemical reaction occurs wherein 1 mole of methanol and 1 mole of water are consumed at the fuel electrode 10 side whereas 1 mole of oxygen is consumed at the oxidizer electrode 8 side, then 3 moles of water are generated at the oxidizer electrode 8 side and 1 mole of carbon dioxide is generated at the fuel electrode 10 side.

Steam vapors produced at the oxidizer electrode 8 are introduced to the water separation part 16 along with the excessive air Ar2, and condensed into the water w by heat radiation, and thus separated from the excessive air Ar2. This water w is recovered into the water tank 18 and recycled as the diluting water for the liquid fuel m.

### Second Embodiment

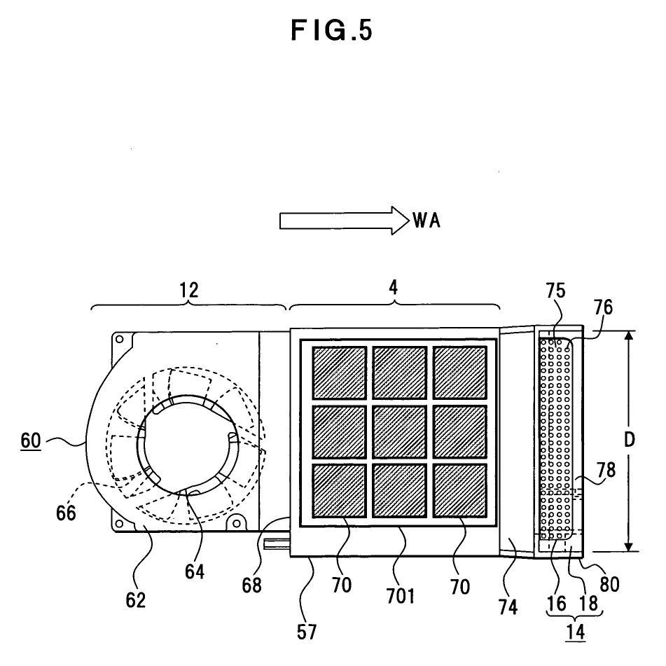

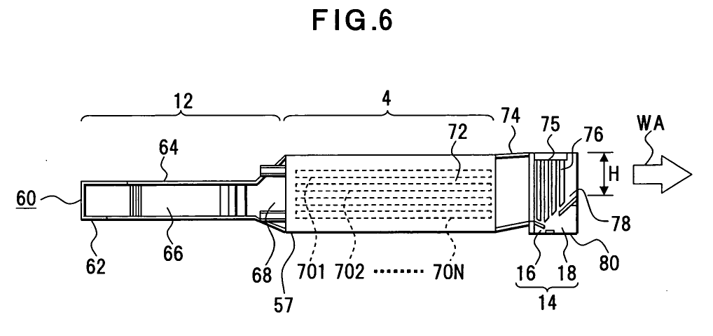

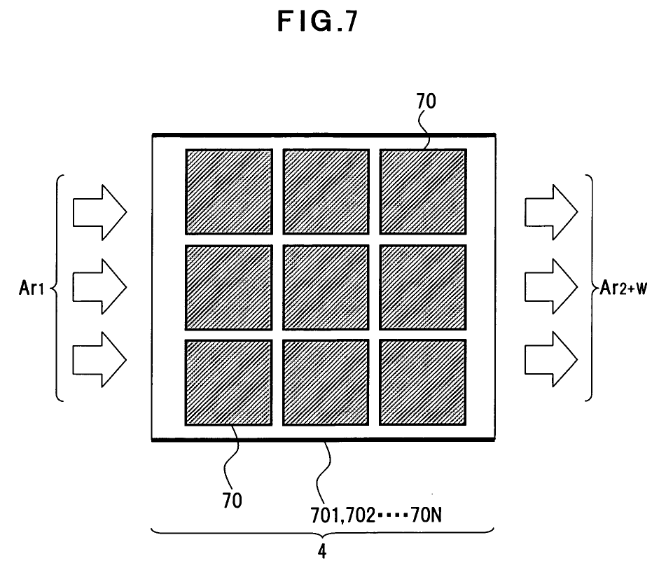

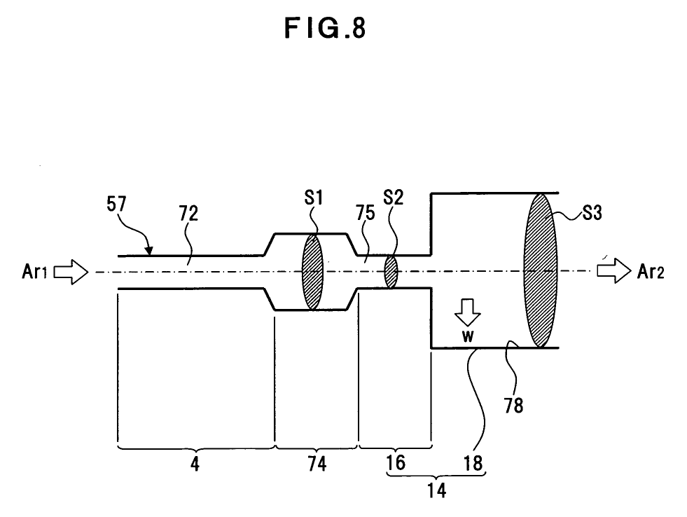

A second embodiment of the present invention will be described with reference to FIGS. 4 to 8. FIG. 4 is a diagram showing an outline of the fuel cell device 2 according to a second embodiment; FIG. 5 is a plan view, whereas FIG. 6 is a diagram viewed from the front, both showing a configuration example of the fuel cell 4, the airflow mechanism 12, and the water recovery mechanism 14; FIG. 7 is a diagram showing a configuration example of the fuel cell 4; and FIG. 8 is a diagram showing a condensation mechanism of the water w by causing pressure changes at the water separation part 16. In FIGS. 4 to 8, the same symbols are assigned to parts identical to those of the fuel cell device 2 in FIG. 1.

As shown in FIG. 4, a cabinet part 57 formed of a single duct structure includes the airflow mechanism 12 and the water recovery mechanism 14 disposed sandwiching the fuel cell 4, and is constructed such that the air Ar1 is added from the airflow mechanism 12 to the fuel cell 4; the excessive air Ar2 having passed through the fuel cell 4 is discharged to the outside air via the water separation part 16 of the water recovery mechanism 14. As described above, the fuel cell 4 is equipped with the oxidizer electrode 8 and the fuel electrode 10 arranged sandwiching the electrolyte membrane 6, and its configuration is the same as shown in FIG. 2.

The water recovery mechanism 14 includes the water tank 18 as well as the water separation part 16, and in this embodiment, the water tank 18 is disposed below the water separation part 16 in order to receive the water w dropped from the water separation part 16 by the pull of gravity. In order to recover the water w, a configuration may also be used in which a water tray is disposed below the water separation part 16 and the water w received therein is introduced to the water tank 18. In this case, even if impurities are included in the water w that is the generated water, the impurities can also be recovered into the water tank 18. The other configuration is the same as that of the fuel cell device 2 shown in FIG. 1.

The airflow mechanism 12 consists of an airflow fan 60 as shown in FIGS. 5, 6. In this airflow fan 60, for example, a circular uptake vent 64 is formed in its sealed cabinet part 62, and a rotary vane 66 rotating by a motor is formed inside the cabinet part 62. When the rotary vane 66 rotates, the air Ar1 taken in from the uptake vent 64 to the inside of the cabinet part 62 is supplied to an air supply part 68.

As shown in FIG. 7, the fuel cell 4 has a stack structure formed of a plurality of cell groups 701, 702, . . . and 70N that consist of a plurality of cells 70. In this embodiment, a matrix where nine cells 70 are arranged into 3 rows and 3 columns constitutes one cell group 701. Other cell groups 702, . . . and 70N have the same structure as the cell group 701, and are stacked in layers at established intervals on the rear surface side. A plurality of channels 72 for flowing the air Ar1 is formed among the cell groups 701, 702, . . . and 70N (FIG. 6). In this embodiment, the air Ar1 is supplied to the channels 72 from the airflow mechanism 12 disposed at the left side of the fuel cell 4. The arrow WA (FIGS. 5, 6) represents flowing direction of the air Ar1 in the channels 72, i.e., the direction of the exhaust airflow. In this embodiment, a first discharge part 74 of the excessive air Ar2 is formed at the right side of the fuel cell 4, i.e., at the opposite side of the airflow mechanism 12 sandwiching the fuel cell 4.

The water recovery mechanism 14 disposed at the discharge part 74 side of the excessive air Ar2 includes the water separation part 16 as well as the water tank 18. The water separation part 16 includes, for example, many fins 76 as a heat radiation part. Each fin 76 is disposed to intersect the direction of airflow of the excessive air Ar2 at right angles. That is, each fin 76 disposed in channels 75 where the excessive air Ar2 passes through narrows the opening area of the channels 75 with its width, thickness, or by the number disposed, and forms a narrow portion in the channels 75. Assuming that S1 is an opening area of the discharge part 74 at the exit part of the fuel cell 4; and S2 is an opening area of the channels 75 formed by the water separation part 16, then the relationship of these sizes becomes S1>S2 because of the fins 76 disposed. Furthermore, in the water separation part 16, an opening 78 is formed as a second discharge part for discharging the excessive air Ar2 after the water w has been separated. In this opening 78, assuming that D is its width (FIG. 5); H is its height (FIG. 6); and S3 is its opening area, and the opening area S3 is set against the opening S2 to become S3>S2. The larger opening area S3 than the S2 is formed at the downstream side of the fins 76. And below the water separation part 16, a water tank 18 is disposed, into which the water w separated from the excessive air Ar2 is recovered. In this manner, the water separation part 16 and the water tank 18 constitute the water recovery mechanism 14 formed of a common cabinet part 80.

Such channels 72, 75 for the air Ar1 and the excessive air Ar2 respectively and the opening areas S1, S2, S3 are configured as shown in FIG. 8. Because of this, the air Ar1 introduced into the fuel cell 4 is subject to pressure changes caused by different opening areas S1, S2, S3 (S1>S2, S3>S2). Therefore, steam vapors contained in the excessive air Ar2 in which oxygen has been consumed by passing through the fuel cell 4 condense into water w, when pressure is released at the opening 78 of the opening area S3 from pressurization at the water separation part 16. This water w is recovered into the water tank 18.

By the way, in this configuration, the fins 76 are disposed in the discharge part of airflow, and below the fins 76, the water recovery mechanism 14 for recovering the water w is disposed. The exhaust airflow having passed through the channels 72 among the flat-shaped cell groups 701 to 70N of the fuel cell 4 passes through the discharge part 74 that is an extension portion of the opening area, and passes through the portion where the fins 76 are disposed, and then is discharged to outside via the opening 78 that is another extension portion. In this manner, the cross-sectional area of the exhaust airflow becomes the narrowest at the portion where the fins 76 are disposed, and becomes wider thereafter. Because of this, the exhaust airflow passing through the fins 76 causes pressure changes by the changes of cross-sectional area and the water w contained in the exhaust air Ar2 is separated. Here, since the fins 76 absorb the heat generated through the pressure changes in the exhaust airflow and cool down the exhaust air, so that the temperature of the fins becomes lower than that of the exhaust air, and as a result, separation of moisture contained in the exhaust air is made possible through this temperature difference from the exhaust air. The amount of water w separated thereat is inversely proportional to the amount of the exhaust airflow per opening area at the discharge part.

Regarding this discharge, it is ideal for the fuel cell 4 that the water w and the liquid fuel m are consumed in equal moles. In such a case, only one third of the amount needs to be recovered out of the generated water. In reality, consumption of equal moles cannot occur since there are excessive diluted fuel M and water w passing through the electrolyte membrane 6. In the fuel cell 4 in which “Nafion” (registered tradename of Du Pont) is used, for example, as a general electrolyte membrane, about 1.5 times of the water w is required to use the diluted fuel M of about 5 [wt %] concentration. Therefore, the generated water needs to be recovered to the extent of about 50 [%] (33×1.5=50).

Note that the fuel cell 4 shown in FIG. 7 indicates a condition in which the flat-shaped cell groups 701 to 70N are stacked. Here, a plurality of cells 70 are arranged into the same number of rows and columns, however, in order to reduce air resistance of passing air Ar1 and to increase an usage ratio of the airflow generated from the airflow fan 60, the number of the cells 70 disposed to intersect the direction of airflow at right angles may be increased while the number of the cells 70 disposed in the same direction as the airflow may be decreased. Note that the amount of moisture that can be recovered depends on the airflow amount and the moisture amount generated by fuel consumption, and it has been confirmed from experiments that the number of stacks of the cells 70 or the number of parallel cells 70 has little effect thereon.

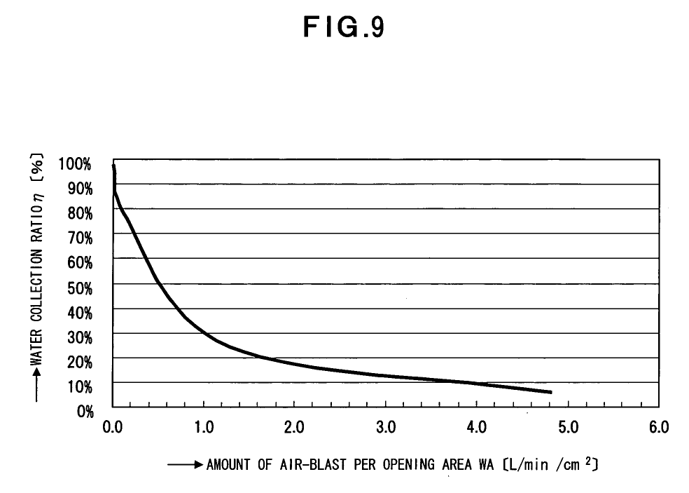

Next, a result of an experiment of the fuel cell 4 according to this configuration will be described with reference to FIG. 9. FIG. 9 is a graph showing the relationship of the water recovery ratio n to the amount of airflow per opening area.

As is clear from this experiment result, the lower WA [L/min/cm²] (amount of airflow per opening area of the water separation part 16), the higher η [%] (water recovery ratio). Therefore, when the excessive air Ar2 that has been put into a pressurization state by the fins 76 reduces its amount due to the opening area S3 at the opening 78, its water recovery ratio increases.

Note that in this experiment, the opening area is set to 17 [m²]; the methanol concentration of the liquid fuel M is set to 5 [wt %]; and the fuel consumption is set to 20 [mL]. In this example, the amount of airflow per opening area capable of recovering about 50 [%] of the generated water is 0.5 [L/min/cm²].

### Third Embodiment

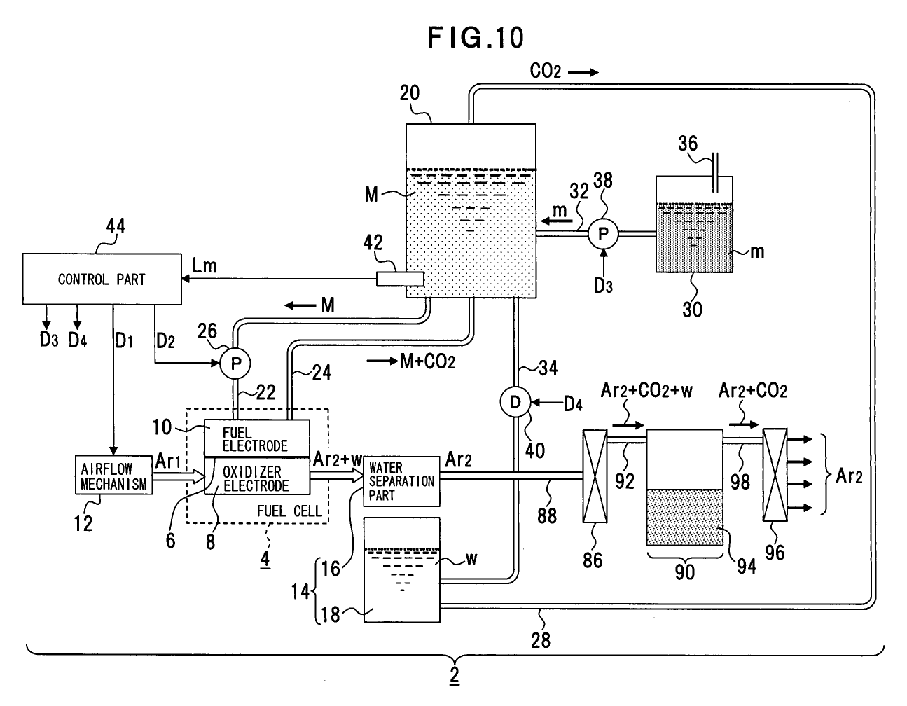

Next, a third embodiment of the present invention will be described with reference to FIG. 10. FIG. 10 is a diagram showing a fuel cell device according to a third embodiment. In FIG. 10, the same symbols are assigned to parts identical to those of the fuel cell device 2 in FIG. 1.

In this embodiment, a filter part 86 is disposed as a second water separation part at the discharge side of the first water separation part 16, and the exhaust air Ar2 leaked from the water separation part 16 is introduced thereto via an exhaust pipe 88, and thus the uncollected water w is recovered by the filter part 86. Since this filter part 86 is comprised of a gas-liquid separation membrane or the like, and although this gas-liquid separation membrane cannot remove moisture absorbed in gases, it has a high capability of removing dewdrops and can recover moisture. Furthermore, a water absorption part 90 is disposed at the discharge side of this filter part 86, and the exhaust air Ar2 having passed through the filter part 86 is introduced thereto via an exhaust pipe 92.

The water absorption part 90 is filled with a water-absorbing material 94. For this water-absorbing material 94, for example, silica gel or the like is used that is used as a drying or moisture-absorbing agent. Silica gel is, as is known, a transparent glassy state solid where amorphous hydrated silica is partially dehydrated. When the exhaust air Ar2, carbon dioxide, and uncollected water w flow into the water absorption part 90 in which such water-absorbing material 94 is filled, the exhaust air Ar2 and carbon dioxide can be dried by hygroscopicity of the water-absorbing material 94.

In addition, a filter part 96 is disposed at the discharge side of the water absorption part 90, and the exhaust air Ar2 having passed through the water absorption part 90 is introduced to the filter part 96 via an exhaust pipe 98. For this filter part 96, a filter that has less filtration density than the filter part 86 and that has a filtration function to the extent that it can block passing of uncollected water and impurities is used.

Although most of the exhaust air Ar2, carbon dioxide CO₂, and the water w having passed through the water tank 18 are recovered into the water tank 18, the exhaust air Ar2 and carbon dioxide CO₂ have yet to be dried up. Therefore, according to this configuration, the exhaust air Ar2 and carbon dioxide having passed through the water tank 18 are introduced into the water absorption part 90 via the exhaust pipe 88 after separation of water w by filtration with filter part 86, and moisture remaining in the exhaust air Ar2 and carbon dioxide CO₂ are absorbed thereat by the water-absorbing material 94, and then discharged to the outside air through the filter part 96. Owing to such a plurality of steps of filtration and moisture absorption, removal and drying of dewdrops can be well performed, and accordingly, even if the temperature of the exhaust air is higher than that of the outside-air, dry air is discharged so that dew condensation can be prevented.

### Fourth Embodiment

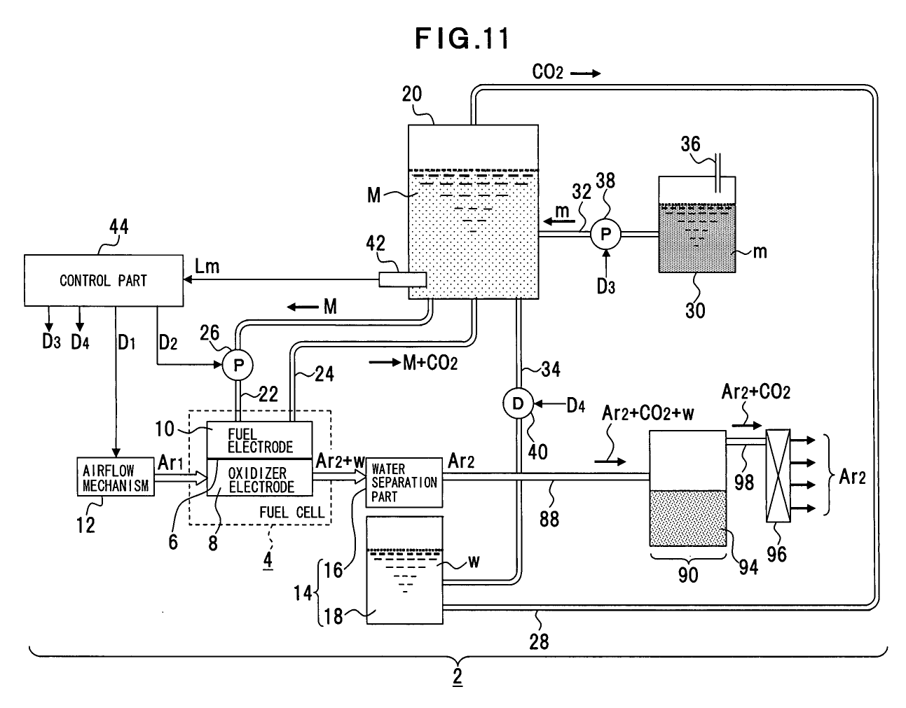

Next, a fourth embodiment of the present invention will be described with reference to FIG. 11. FIG. 11 is a diagram showing a fuel cell device according to a fourth embodiment. In FIG. 11, the same symbols are assigned to parts identical to those of the fuel cell device 2 in FIG. 10.

In the fuel cell device 2 of this embodiment, the water absorption part 90 is disposed at the discharge side of the water separation part 16, and the exhaust air Ar2 is introduced into this water absorption part 90 via the exhaust pipe 88. The water absorption part 90 is filled with the above-described (third embodiment) water-absorbing material 94. For this water-absorbing material 94, for example, silica gel or the like is used that is used as a drying or moisture-absorbing agent. Silica gel is the same as above described. Therefore, when the exhaust air Ar2, carbon dioxide CO₂, and uncollected water w flow into the water absorption part 90 in which the water-absorbing material 94 is filled, the exhaust air Ar2 and carbon dioxide can be dried by hygroscopicity of the water-absorbing material 94.

In addition, the filter part 96 is disposed at the discharge side of the water absorption part 90, and the exhaust air Ar2 having passed through the water absorption part 90 is introduced to the filter part 96 via an exhaust pipe 98. For this filter part 96, a filter that has less filtration density than the filter part 86 and has a filtration function to the extent that it can block passing of uncollected water and impurities is used.

According to such a configuration, the exhaust air Ar2 and carbon dioxide CO₂ having passed through the water tank 18 are introduced to the water absorption part 90 via the exhaust pipe 88, and then discharged to the outside air through the filter part 96, after the moisture remaining in the exhaust air Ar2 and carbon dioxide are absorbed thereat by the water-absorbing material 94. In this way, also by configuring that the exhaust air Ar2 is discharged through the filter part 96, after the moisture is removed at the water absorption part 90 from the exhaust air Ar2 sent from the water separation part 16, dry air can be discharged similarly, and prevention of dew condensation can be achieved.

### Fifth Embodiment

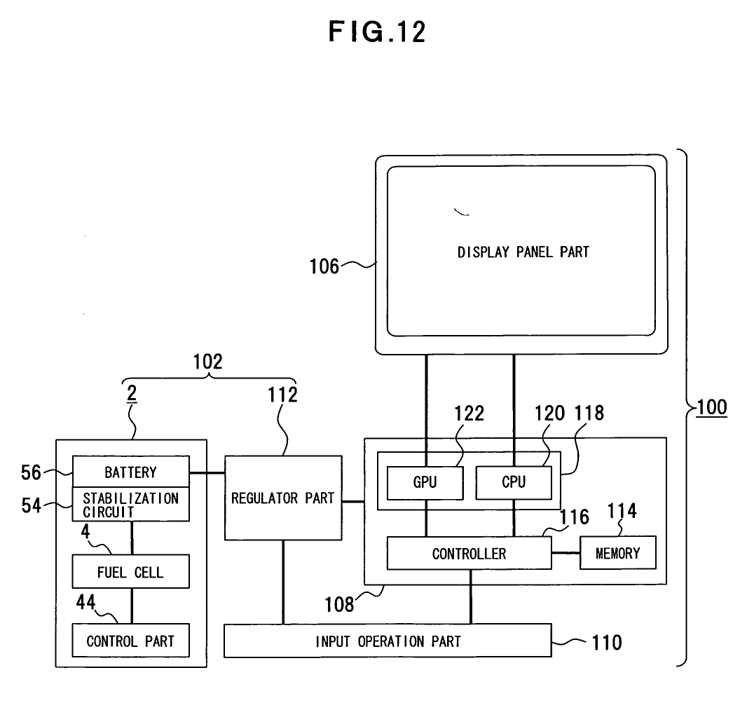

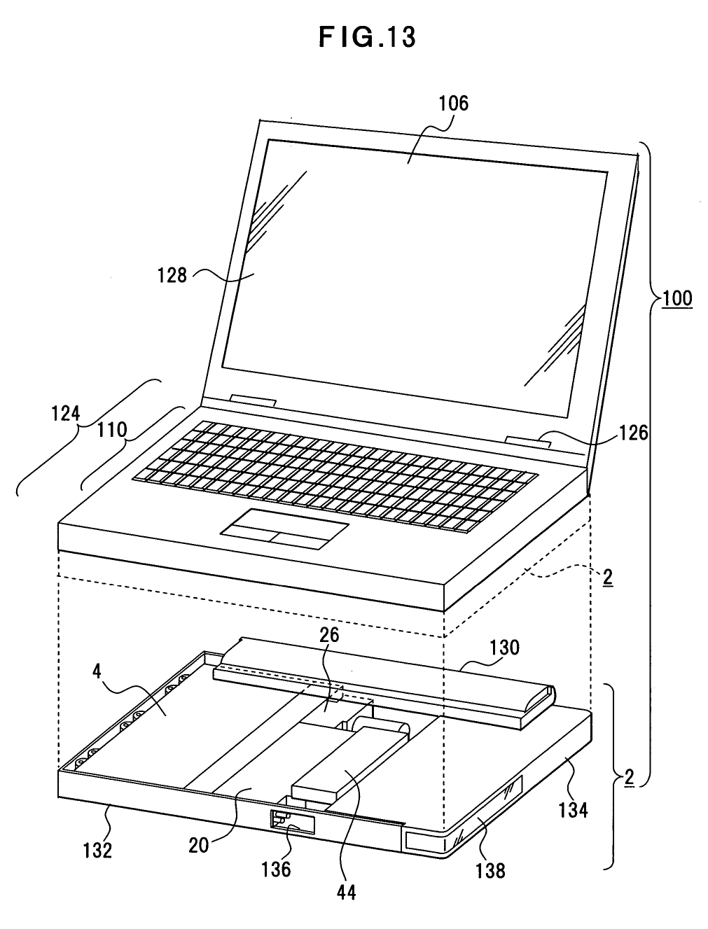

Next, a fifth embodiment of the present invention will be described with reference to FIGS. 12, 13. FIG. 12 is a block diagram showing a personal computer (PC) in which a fuel cell device is mounted, whereas FIG. 13 is an exploded perspective view of a PC showing its specific configuration example. In FIGS. 12, 13, the same symbols are assigned to parts identical to those of the first embodiment (FIGS. 1, 2).

A PC 100 of this embodiment is an example of an electronic appliance 58 in which the fuel cell device 2 is mounted. In a power source part 102 of the PC 100, the fuel cell device 2 is disposed, and in this fuel cell device 2, the fuel cell 4, the control part 44, and the like are disposed as described above. The fuel cell device 2 of this embodiment is provided with a stabilization circuit 54 and a battery 56 as a secondary battery. Furthermore, the PC 100 includes a display panel part 106, a circuit board 108, an input operation part 110, a regulator part 112, and the like. The input operation part 110 consists of a mouse, a keyboard, and the like. Further, various types of memories 114, a controller 116, a motherboard 118, or the like are mounted/on the circuit board 108, and a CPU (Central Processing Unit) 120, a GPU (Graphic Processing Unit) 122, or the like are mounted on the motherboard 118. The GPU 122 controls the display at the display panel part 106.

According to such a configuration, the electricity generated at the fuel cell 4 is added to the battery 56 after having been stabilized by the stabilization circuit 54, and the battery 56 is charged therewith. The output of this battery 56 is supplied to the circuit board 108, the input operation part 110, and the display panel part 106, after having been converted into a predetermined voltage by the regulator part 112.

In the PC 100 using such a fuel cell device 2 for its power source, its electricity supply continues for a long time by simply replacing such as fuel and water, instead of replacing batteries in conventional art, so that continuous processing operations are made possible and the PC 100 with enhanced convenience is realized.

In addition, display information such as fuel depletion and anomalies of fuel concentration in the fuel cell device 2 may be inputted from the control part 44 into the controller 116 of the PC 100 to display a message on the display panel part 106. According to such a configuration, users can find fuel depletion of the fuel cell device 2 and its operation status from the display on the display panel part 106.

In this PC 100, for example, as shown in FIG. 13, a cabinet part 124 and a display panel part 106 are constructed to be openable/closable via a hinge part 126, and in the cabinet part 124, an input operation part 110 including a plurality of keys and the like is disposed as well as the above-described circuit board 108 and the like. In the display panel part 106, for example, an LCD (Liquid Crystal Display) 128 is disposed as a display part.

Further, on the rear part of the cabinet part 124 of this PC 100, the fuel cell device 2 is mounted along with a battery pack 130. For instance, the battery pack 130 is embedded inside the cabinet part 124, and the fuel cell device 2 is either fixed to be integrated into the rear part of the cabinet part 124 or detachably attached thereto. The battery pack 130 consists of a secondary cell such as the above-described battery 56 (FIG. 2), and charged by the fuel cell device 2.

The fuel cell device 2 includes a cabinet part 132 corresponding to the cabinet part 124 of the PC 100, and in this cabinet part 132, a fuel cell 4, the airflow mechanism 12, the diluted fuel tank 20, the water absorption part 90, the combined fuel tank unit 134 configured to be removable in which the filter part 96 and the liquid fuel tank 30 are combined together, and the like are disposed. There is a vent part 136 formed on the cabinet part 132 to take in the outside air, and the vent part 136 is covered with a breathing waterproof sheet that is not shown.

There is a check window 138 formed on a side part of the combined fuel tank unit 134 of this embodiment in order to check remaining amount of the fuel inside. This combined fuel tank unit 134 can be detached/attached separately from the cabinet part 132. Thus, the remaining amount of the liquid fuel m can be checked easily from the check window 138, making replacements of the combined fuel tank unit 134 easier.

According to the PC 100 in which the above-described fuel cell device 2 is mounted, since operations such as replacing rechargeable batteries can be saved and a stable power supply for many hours can be obtained from the fuel cell device 2 simply by replacing the fuel, so that continuous operations can be realized and the convenience and mobility especially for a mobile PC can be further increased.

### Sixth Embodiment

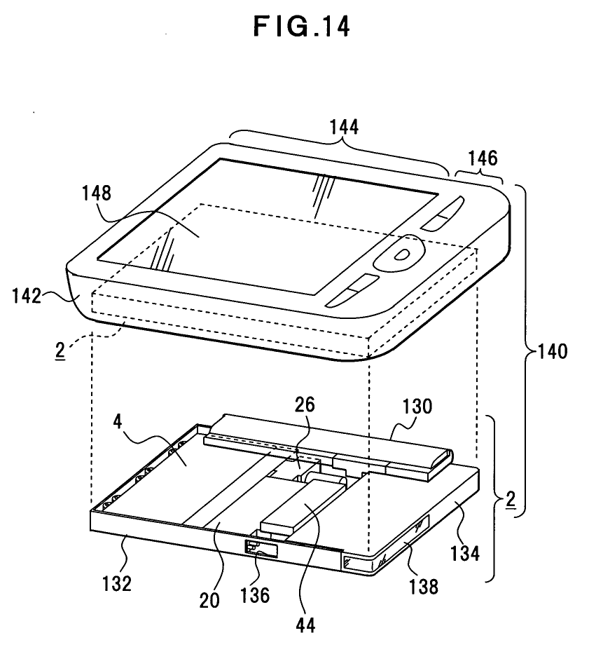

A sixth embodiment of the present invention will be described with reference to FIG. 14. FIG. 14 is a diagram showing a configuration example of a mobile information terminal called PDA (Personal Digital Assistant) on which a fuel cell device 2 is mounted. In FIG. 14, the same symbols are assigned to parts identical to those of the above-described embodiment.

A PDA 140 is an example of an electronic appliance on which the fuel cell device 2 is mounted. In this PDA 140, a display panel part 144 and an input operation part 146 including a plurality of keys or the like are disposed on a cabinet part 142 as well as the above-described circuit board 108 and the like. Further, an LCD 148, for example, is disposed as a display part on the display panel part 144. The fuel cell device 2 corresponding to the cabinet part 142 is disposed on the rear part of this PDA 140. The configuration of the fuel cell device 2 is the same as above described.

In this manner, according to the PDA 140 on which the fuel cell device 2 is mounted, since operations such as replacing rechargeable batteries can be saved and a stable power supply for many hours can be obtained from the fuel cell device 2 simply by replacing the fuel, so that continuous operations can be ensured, and the convenience and mobility can be further increased.

### Seventh Embodiment

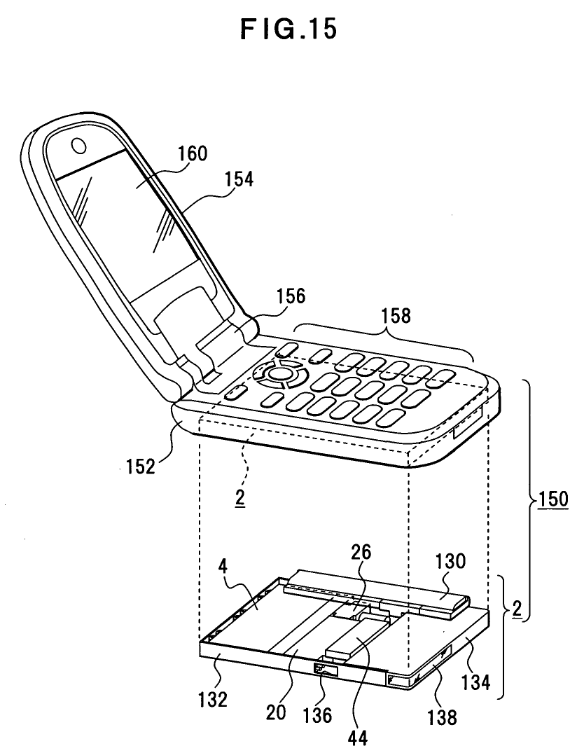

A seventh embodiment of the present invention will be described with reference to FIG. 15. FIG. 15 is a diagram showing a configuration example of a mobile phone on which a fuel cell device 2 is mounted. In FIG. 15, the same symbols are assigned to parts identical to those of the above-described embodiment.

As a wireless communication device or a mobile terminal, a mobile phone 150, for example, is an example of an electronic appliance on which the fuel cell device 2 is mounted. In this mobile phone 150, a cabinet part 152 and a cabinet part 154 are configured to be openable/closable via a hinge part 156, and on the cabinet part 152, an input operation part 158 composed of a plurality of keys is disposed, and on the cabinet part 154, a display part, for example, an LCD 160 is disposed. The fuel cell device 2 is disposed on the rear part of the cabinet part 152. The configuration of the fuel cell device 2 is the same as above described.

In this manner, according to the mobile phone 150 on which the fuel cell device 2 is mounted, since operations such as replacing rechargeable batteries can be saved and a stable power supply for many hours can be obtained from the fuel cell device 2 simply by replacing the fuel, so that continuous operations can be ensured, and the convenience and mobility can be further increased.

### Other Embodiments

Next, other embodiments and their features and advantages will be described by listing hereinbelow.

(1) Although in the above embodiments, a PC, a PDA, and a mobile phone have been exemplified as electronic appliances mounting the fuel cell device 2, other electronic appliances such as a camera and a radio may also be used. The same effects such as realizing stable operations for many hours can be expected simply by supplying the fuel without replacing rechargeable batteries or the like.

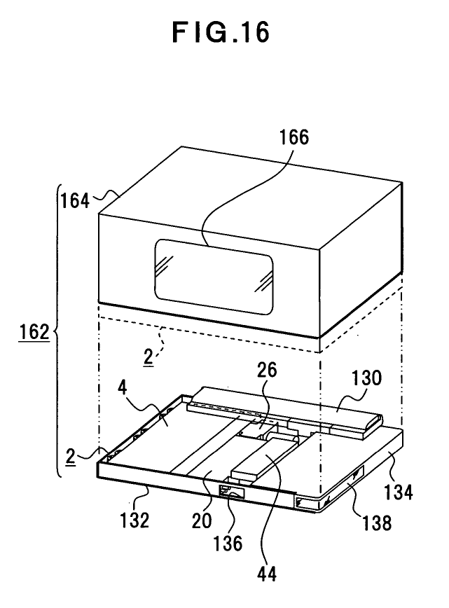

(2) As an electronic appliance in which the fuel cell device 2 is mounted, for example, as shown in FIG. 16, the fuel cell device 2 may be attached to a main body 164 of a lighting fixture 162 such as flashlights either to be removable or integrated. A 166 is a light-emitting part. According to such a configuration, the same effects can be expected and convenience as a disaster prevention appliance can be increased.

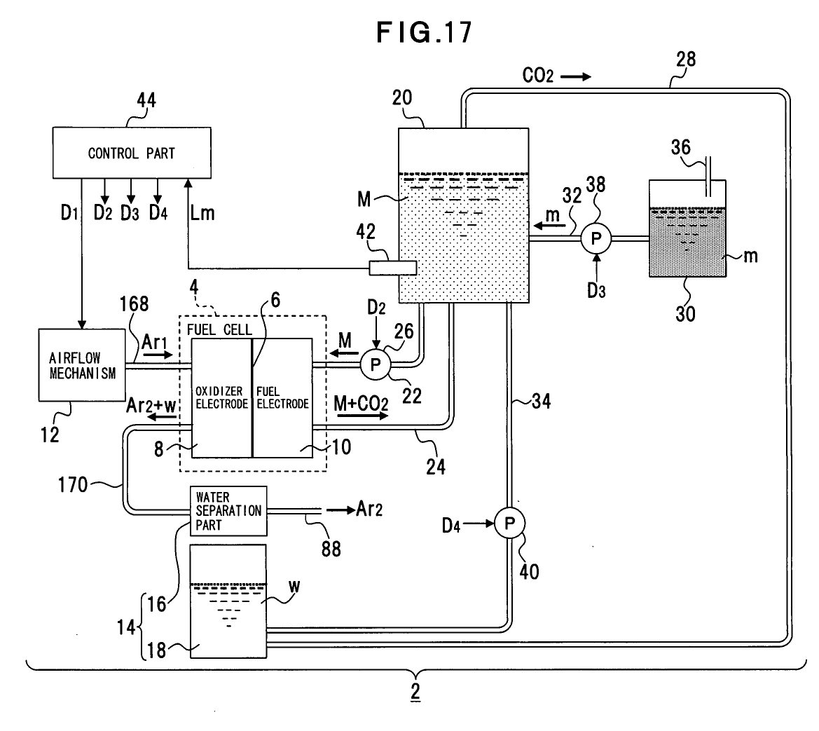

(3) In the above-described embodiment, as shown in FIG. 4, the fuel cell device 2 using the cabinet part 57 forming a duct structure has been described, however, as shown in FIG. 17, the device may also be configured such that the airflow mechanism 12 and the fuel cell 4 are connected to each other via an air supply pipe 168, whereas the fuel cell 4 and the water separation part 16 are connected to each other via a recovery pipe 170.

A most preferred embodiment and the like of the present invention have been described above. However, the present invention is not limited to the above description; it goes without saying that various modifications and alterations may be made by a person skilled in the art on the basis of the gist of the invention that is described in the claims and disclosed in the detailed description of the invention, and that such modifications and alterations are included in the scope of the present invention.

The present invention relates to a fuel cell device, and is useful such that it can increase recovery ratio of the steam vapors discharged from the fuel cell along with the exhaust air generated in the fuel cell; simplify its recovery structure; realize a fuel cell device capable of preventing dew condensation; and realize a highly reliable electronic appliance by mounting such a fuel cell device thereon.

The entire disclosure of Japanese Patent

Application No. 2005-067867 including specification, claims, drawings and summary are incorporated herein by reference in its entirety.

What is claimed is:

1. A fuel cell device using a liquid fuel, comprising a water separation part enabling to separate water from exhaust air generated in the fuel cell to which the fuel is supplied along with air, by letting the exhaust air pass through and by causing pressure changes in the exhaust airflow.

2. The fuel cell device of claim 1, wherein the water separation part further comprises channels to flow the exhaust air, the channels including a narrow portion formed therein to cause pressure changes in the exhaust air passing thereat to enable separation of water from the exhaust air.

3. The fuel cell device of claim 1, wherein the water separation part further comprises fins disposed in the channels to flow the exhaust air, the fins forming the narrow portion in the channels.

4. The fuel cell device of claim 1, further comprising a water recovery tank to recover the water separated by the water separation part, wherein the water recovered into the water recovery tank is used as diluting water for the liquid fuel.

5. The fuel cell device of claim 1, further comprising an airflow mechanism to send the air to the fuel cell with pressure.

6. The fuel cell device of claim 1, wherein the fuel cell further comprises a stack structure formed of a plurality of cell groups consisting of a plurality of cells disposed in a flat shape and air channels formed among each cell group.

7. The fuel cell device of claim 1, wherein the fuel cell is configured to flow the air from the airflow mechanism into the air channels formed among the respective cell groups constructed by stacking a plurality of cell groups consisting of a plurality of cells and to discharge the air having passed through the cell groups.

8. The fuel cell device of claim 1, wherein the water separation part is integrated with the fuel cell and the airflow mechanism supplying air to an oxidizer electrode of the fuel cell.

9. The fuel cell device of claim 1, wherein the fuel cell is comprised of an oxidizer electrode supplying air to one side of an electrolyte membrane and a fuel electrode supplying fuel to the other side of the electrolyte membrane, the electrodes being disposed sandwiching the electrolyte membrane.

10. The fuel cell device of claim 4, wherein the water recovery tank is disposed adjacent to the water separation part to recover the water dropped from the water separation part.

11. The fuel cell device of claim 9, wherein the electrolyte membrane is a permeable membrane letting protons or electrons pass through.

12. The fuel cell device of claim 1, further comprising:
a stabilization circuit to extract electricity output from the fuel cell after stabilization; and
a battery charged by receiving the output from this stabilization circuit.

13. A fuel cell device using a liquid fuel, comprising:
a diluted fuel tank to store a diluted fuel diluted with water;
a concentration sensor to detect a concentration of the diluted fuel in the diluted fuel tank;
a fuel tank to store fuel;
a water tank to store water; and
a concentration control part to maintain concentration of the diluted fuel to a predetermined concentration by supplying the fuel from the fuel tank and by supplying the water from the water tank to the diluted tank, depending on a detected concentration by the concentration sensor.

14. An electronic appliance comprising a fuel cell device in its power source part, wherein the fuel cell device further comprises a water separation part enabling to separate water from exhaust air generated in the fuel cell to which the fuel is supplied along with air, by letting the exhaust air pass through and by causing pressure changes in the exhaust airflow.

15. The electronic appliance of claim 14, further comprising:
a stabilization circuit to extract electricity output from the fuel cell device after stabilization; and
a battery charged by receiving the output from this stabilization circuit.

16. The electronic appliance of claim 14, wherein the water separation part disposed in the fuel cell device further comprises channels to flow the exhaust air, the channels including a narrow portion formed therein to cause pressure changes in the exhaust air passing therein to enable separation of water from the exhaust air.

17. The electronic appliance of claim 14, wherein the water separation part disposed in the fuel cell device further comprises fins disposed in channels to let the exhaust air flow through, in such a manner that the fins form a narrow portion in the channels.

18. The electronic appliance of claim 14, wherein the fuel cell device further comprises a water recovery tank to recover the water separated by the water separation part, in such a manner that the water recovered into the water recovery tank is used as diluting water for the liquid fuel.

19. The electronic appliance of claim 14, further comprising a fuel tank removably attached to a cabinet part of the fuel cell device.
